(19) United States
(12) Patent Application Publication
(10) Pub. No.: US 2010/0237014 A1
(43) Pub. Date: Sep. 23, 2010

(54) MEMBRANE MODULE WITH MULTIPLE BOTTOM HEADERS AND FILTRATION PROCESS

(76) Inventors: Steven K. Pedersen, Burlington (CA); Pierre Lucien Cote, Dundas (CA); Nicholas Willam Harcsar Adams, Hamilton (CA)

Correspondence Address: BERESKIN & PARR (MISSISSAUGA) / GE, SCOTIA PLAZA, 40 KING STREET WEST, 40TH FLOOR, TORONTO, ON, M6H-3V2, CA

(21) Appl. No.: 12/599,599

(22) PCT Filed: May 8, 2008
(86) PCT No.: PCT/US2008/063038

§ 371 Date: Nov. 10, 2009

Related U.S. Application Data
(60) Provisional application No. 60/917,460, filed on May 11, 2007.
(60) Provisional application No. 60/924,572, filed on May 21, 2007.

(51) Int. Cl. C02F 1/44; B01D 63/02; B01D 61/14; B01D 63/04

(52) U.S. Cl. 210/650; 210/321.72; 210/321.75; 210/151; 210/253; 210/197

(57) ABSTRACT

A membrane module (100) has an upper header.(108) and multiple lower headers (110). A bundle of membranes (24) potted in the upper header is sub-bundled into the lower headers. The membranes (24) may be arranged in the upper header into a number of generally parallel sheets or planes and arranged into a lower header (110) into a lesser number of sheets or planes. Spaces between the multiple lower headers (110) help gas bubbles rise into the module (100) or water containing solids drain from the module (100). The module (100) may be used in batch or continuous filtration processes. In one specific process, water flows downwards through the module (100) and air bubbles are provided from near the bottom of the module (100).

For the United States of America, this application claims the benefit under 35 USC 119(e) of U.S. Application No. 60/917,460 filed on May 11, 2007 to Pierre L. Cote and U.S. Application No. 60/924,572 filed on May 21, 2007 to Nicholas W. H. Adams and Steven K. Pedersen, both of which are incorporated herein in their entirety by this reference to them.

### FIELD

This specification relates to membrane separation devices and processes as used, for example, water or wastewater treatment.

### BACKGROUND

The following background discussion is not an admission that anything discussed below is citable as prior art or part of the knowledge of persons skilled in the art in any country.

U.S. Pat. No. 6,325,928 describes a filtering element having ultrafiltration or microfiltration hollow fibre membranes extending horizontally between a pair of opposed horizontally spaced, vertically extending headers. Side plates extending between the pair of vertically extending headers define a vertical flow channel through the element. Modules or cassettes are created by placing the elements side by side or in an orthogonal grid.

Another membrane module and cassette are described in U.S. Publication No. 2002/0179517. In this publication an apparatus for filtering a liquid in a tank has a plurality of elements and a frame for holding the elements while they are immersed in the liquid. The elements have a plurality of hollow fibre membranes attached to and suspended between an upper header and a lower header. The size and configuration of the frame determines the positions of the upper and lower headers of each element relative to each other.

A batch filtration process using immersed membrane modules may have a repeated cycle of concentration and deconcentration steps. During the concentration step, permeate is withdrawn from a fresh batch of feed water initially having a low concentration of solids. As the permeate is withdrawn, fresh water is introduced to generally replace the water withdrawn as permeate. During this step, which may last for example from 10 minutes to 4 hours, solids are rejected by the membranes and do not flow out of the tank with the permeate. As a result, the concentration of solids in the tank increases, for example to between 5 and 50, times the initial concentration. The process then proceeds to the deconcentration step. In the deconcentration step, which may be between 1/50 and ⅕ the duration of the concentration step, a large quantity of solids are rapidly removed from the tank to return the solids concentration back to or near the initial concentration. This may be done by completely draining the tank and refilling it with new feed water. To help move solids away from the membranes themselves, air scouring and backwashing may be used before or during the deconcentration step.

Another filtration process is a feed and bleed process. In a feed and bleed process, feed water flows generally continuously into a tank. Permeate is withdrawn generally continuously, but may be stopped from time to time for example for backwashing. Retentate is removed from the tank while permeating from time to time, periodically or continuously. The average flow rate of retentate may be 1-20% of the feed flow rate, the remainder of the feed flow being removed as permeate. Aeration may be provided continuously or intermittently during permeation.

A wastewater treatment plant and process are described in International Publication No. WO 2005/039742. In this publication a liquid plant has sets of membrane tanks and process tanks with flow between them through channels. Watewater being treated is recirculated through the membrane tanks and process tanks while permeate is withdrawn. Sludge is wasted from the plant from time to time.

U.S. Pat. No. 6,325,928, U.S. Publication No. 2002/0179517 and International Publication No. WO 2005/039742 are incorporated herein, in their entirety, by this reference to them.

### SUMMARY

The following summary is intended to introduce the reader to the more detailed discussion to follow and not to define any invention. One or more inventions may reside in any combination of one or more apparatus elements or process steps described in this summary or in other parts of this document, for example the detailed description, figures or claims.

The inventors have discovered that, to decrease the capital cost of immersed, suction driven, air scrubbed membrane systems per unit of membrane surface area, cassette packing densities (membrane surface area per unit cassette volume) may be increased. To decrease energy costs, average specific air flow rates (average flow rate of air per unit membrane area) may be decreased, for example by increasing the ratio of air off to on time in a cyclic or intermittent aeration regime or by reducing the air flow rate when the air is on. However, cassette sludging, meaning a build up of partially dried solids on the membranes on a part of the cassette, is a significant problem and limits how far cassette packing density can be increased or air flow rates can be decreased. Sludging is affected by, among other things, the solids mass flux into and out of a cassette, or the ratio of the mixed liquor flow rate through a cassette to the permeate removal rate. For example, reducing aeration where aeration is used to air lift water through a cassette reduces mixed liquor flow through a cassette and so increases sludging. While these observations were made primarily in continuous process wastewater treatment applications, similar or analogous issues have been observed or are expected by the inventors in other applications, for example batch or feed and bleed process water filtration.

The inventors have also discovered that poor air flow distribution, particularly the presence of dead zones, also causes local areas of low solids mass flow out of a cassette and increases sludging. Further, spaces left in a tank for mixed liquor circulation outside of a cassette allow recirculating mixed liquor flows to bypass the cassette when air is off or at a low rate, for example during a low or no flow part of recycled or intermittent aeration regime. The inventors have further discovered that the effectiveness of bubbles used to scour membranes increases with the amount of the time that the bubbles remain in the area of a membrane module and further that small bubbles, for example bubbles of 5 mm or less in diameter, may be effective for scouring membranes. Following these discoveries, the inventors have invented various apparatuses and processes for treating water, including waste water. These apparatuses or processes may be resistant to sludging or may provide desirable performance levels, such as a high sustainable flux or low energy use.

A membrane module may have an upper header and multiple lower headers. The module, and its headers, may be generally rectangular in plan view. The lower headers may be parallel to each other and spaced across the width of the module. A bundle of membranes potted in the upper header may be sub-bundled in the lower headers. The membranes may be arranged in the upper header into a number of generally parallel sheets or planes and arranged into a lower header into a lesser number of sheets or planes. The module may be shrouded. Multiple modules may be combined into larger assemblies.

A module as described above may be used in a batch filtration process. In such a process, spaces between the multiple lower headers help gas bubbles rise into the module. The spaces between the multiple lower headers also helps water containing solids drain from the module. Other processes may also be used. For example, the module may be used in a process in which activated sludge is recirculated through a tank containing a membrane module with air bubbles provided during permeation. Optionally, the activated sludge may be recirculated such that it flows downwards through the module.

A filtration system may comprise one or more membrane cassettes in a tank. The cassettes may cover a large proportion, for example 90% or more, of the width or horizontal or vertical cross-sectional surface area of the tank or a shrouded portion of the tank such that it is difficult for mixed liquor to bypass the cassettes by flowing beside the cassettes downwards or along the length of the tank without first passing through the cassettes. If there are multiple cassettes, the cassettes may be separated by vertical non-porous plates spanning a vertical portion of the width of the tank or the shrouded area of the tank so as to provide parallel flow paths through multiple cassettes. An inlet to the tank may be separated from an outlet such that mixed liquor flows through these cassettes generally in parallel. Mixed liquor may flow from the bottom of the cassettes to the top, horizontally through the cassettes, or, preferably, from the top to the bottom of the cassettes. An aeration system may provide air bubbles from below or near the bottom of the cassettes. The tank may be part of a treatment plant having a mixed liquor recycle through the tank. For example, the tank may be a membrane tank as shown in any of the plants of International Publication No. WO 2005/039742. The cassettes may be as shown in U.S. Publication No. 2002-0179517 or as shown in U.S. Publication No. 2002-0179517 but without a lower header, the lower ends of the membranes instead being sealed and free or collected together in groups, for example, strips. Gaps between upper membranes or a baffle near the upper headers may be sized such that the local velocity of water through the gaps is greater than the rise velocity of small bubbles.

In a water treatment process, mixed liquor may flow through a cassette from top to bottom. The mixed liquor may be recirculated through the tank, that is the flow of mixed liquor out of the tank may be more than the average feed flow to the entire plant. Scouring bubbles may be provided continuously, cyclically or intermittently. Mixed liquor may be recirculated through the tank, for example at a rate of 3-5 Q. In one example, mixed liquor may flow downwards through a cassette at a rate that produces a velocity of, for example, 3-20 cm/s or 10-20 cm/s through gaps between filtration units within the cassette. Scouring bubbles may be provided with an average size, or including sizes, having a rise velocity in still water similar to, for example between 50% and 200% or between 100% and 200% of, the velocity of mixed liquor through the gaps. Where filtration units have no lower headers, or gaps for water to flow through the bottom of the filtration units are larger than gaps for water to flow through the tops of the filtration unit, or the rate of permeate removal relative to recirculation flow is significant, bubbles may be provided with size having a rise velocity sufficient to rise upwards into the area of the filtration units, but insufficient to rise above the filtration units. In this way, bubbles are retained in the cassette for a longer period of time than when bubbles move through still water or create an air lift and bubbles may be trapped in the area of the filtration units until they coalesce into larger bubbles. Further, where hollow fiber membranes are used, mixed liquor velocity may be lower within the membrane units than between membrane units which encourages bubbles to flow upwards through the membrane units rather than through spaces between the membrane units. Air bubbles may be provided cyclically, for example in a cycle of 5 to 20 seconds, for example 10 to 15 seconds, at a higher rate and then 10 to 50 seconds, for example 20 to 40 seconds, at a lower rate which may be in the range of no flow to 20% of the higher rate. The cycles or other aeration may be provided generally throughout a permeation period.

### BRIEF DESCRIPTION OF THE DRAWINGS

FIG. 1 is a schematic diagram of a filtration apparatus.

FIG. 2 is an exploded, isometric, schematic diagram of a module.

FIG. 3 is an exploded, isometric, schematic view of a cassette comprising a module of FIG. 2.

FIG. 4 is an assembled isometric, schematic view of the cassette of FIG. 3.

FIG. 5 is a cross section of a header during potting.

FIG. 6 is a cross-section of a membrane tank that may be part of a waste water treatment plant.

FIG. 7 is an elevation view of the tank of FIG. 1.

FIG. 8 is a plan view of the tank of FIG. 1.

FIGS. 9 and 10 are side and plan views, respectively, of a portion of the tank of FIG. 6 with a modified filtration unit.

FIG. 11 is a schematic cross section of another module.

### DETAILED DESCRIPTION

Various apparatuses or processes will be described below to provide an example of an embodiment of each claimed invention. No embodiment described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention.

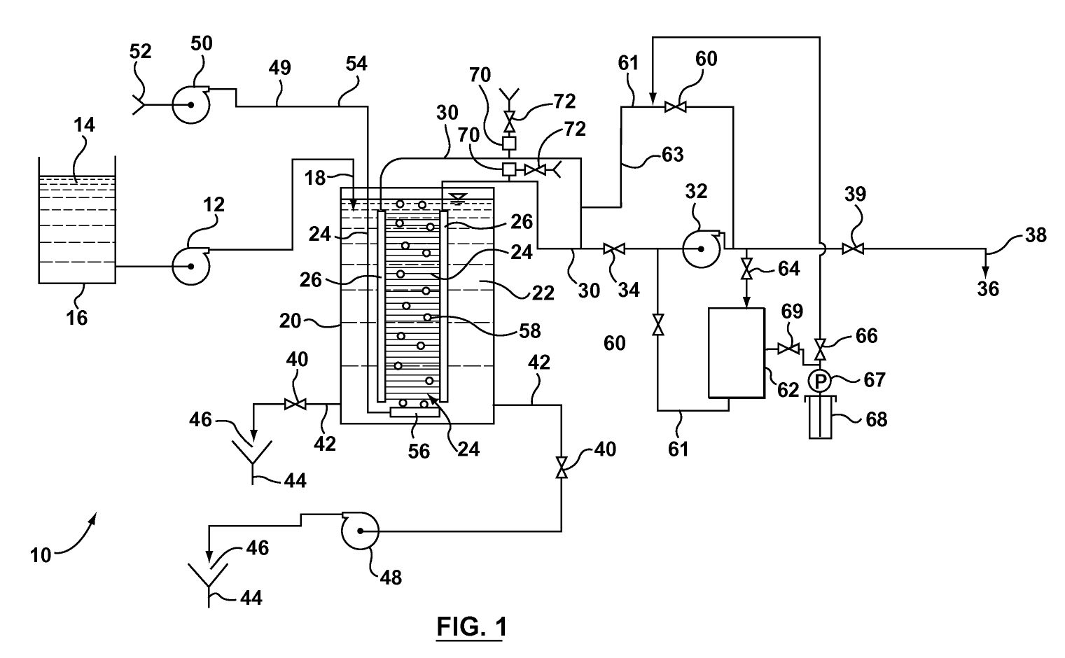

Referring to FIG. 1, a reactor 10 is shown for treating a liquid feed having solids to produce a filtered permeate with a reduced concentration of solids and a retentate with an increased concentration of solids. Such a reactor 10 has many potential applications, but will be described below as used for creating potable water from a supply of water such as a lake, well, or reservoir. Such a water supply typically contains colloids, suspended solids, bacteria and other particles or substances which must be filtered out and will be collectively referred to as solids whether solid or not.

The first reactor 10 includes a feed pump 12 which pumps feed water 14 to be treated from a water supply 16 through an inlet 18 to a tank 20 where it becomes tank water 22. Alternatively, a gravity feed may be used with feed pump 12 replaced by a feed valve. Each membrane 24 has a permeate side 25 which does not contact the tank water 22 and a retentate side which does contact the tank water 22. The membranes 24 may be hollow fibre membranes 24 for which the outer surface of the membranes 24 is the retentate side and the lumens of the membranes 24 are the permeate side 25.

Each membrane 24 is attached to one or more headers 26 such that the membranes 24 are surrounded by potting material to produce a watertight connection between the outside of the membranes 24 and the headers 26 while keeping the permeate side 25 of the membranes 24 in fluid communication with a permeate channel in at least one header 26. The permeate channel is connected to a permeate collector 30 and a permeate pump 32 through a permeate valve 34. Air entrained in the flow of permeate through the permeate collectors 30 becomes trapped in air collectors 70, typically located at at least a local high point in a permeate collector 30. The air collectors 70 are periodically emptied of air through air collector valves 72 which may, for example, be opened to vent air to the atmosphere when the membranes 24 are backwashed. Filtered permeate 36 is produced for use at a permeate outlet 38 through an outlet valve 39. Periodically, a storage tank valve 64 is opened to admit permeate 36 to a storage tank 62. The filtered permeate 36 may require post treatment before being used as drinking water, but should have acceptable levels of colloids and other suspended solids. The membranes 24 may have an average pore size in the microfiltration or ultrafiltration range, for example between 0.003 microns and 10 microns or between 0.02 microns and 1 micron.

Tank water 22 which does not flow out of the tank 20 through the permeate outlet 38 flows out of the tank 20 at some time through a drain valve 40 and a retentate outlet 42 to a drain 44 as retentate 46 with the assistance of a retentate pump 48 if necessary.

To provide air scouring, alternately called aeration, an air supply pump 50 blows ambient air, nitrogen or other suitable gases from an air intake 52 through air distribution pipes 54 to aerator 56 or sparger which disperses scouring bubbles 58. The bubbles 58 rise through the membranes 24 and discourage solids from depositing on the membranes 24. In addition, where the design of the reactor 10 permits it, the bubbles 58 also create an air lift effect which in turn circulates the local tank water 22.

To provide backwashing, permeate valve 34 and outlet valve 39 are closed and backwash valves 60 are opened. Permeate pump 32 is operated to push filtered permeate 36 from retentate tank 62 through backwash pipes 61 and then in a reverse direction through permeate collectors 30 and the walls of the membranes 24 thus pushing away solids. At the end of the backwash, backwash valves 60 are closed, permeate valve 34 and outlet valve 39 are re-opened and pressure tank valve 64 opened from time to time to re-fill retentate tank 62.

To provide chemical cleaning from time to time, a cleaning chemical such as sodium hypochlorite, sodium hydroxide or citric acid is provided in a chemical tank 68. Permeate valve 34, outlet valve 39 and backwash valves 60 are all closed while a chemical backwash valve 66 is opened. A chemical pump 67 is operated to push the cleaning chemical through a chemical backwash pipe 69 and then in a reverse direction through permeate collectors 30 and the walls of the membranes 24. At the end of the chemical cleaning, chemical pump 67 is turned off and chemical pump 66 is closed. Preferably, the chemical cleaning is followed by a permeate backwash to clear the permeate collectors 30 and membranes 24 of cleaning chemical before permeation resumes.

To fill the tank 20, a feed pump 12 pumps feed water 14 from the water supply 16 through the inlet 18 to the tank 20 where it becomes tank water 22. The tank 20 is filled when the level of the tank water 22 completely covers the membranes 24 in the tank 20 but the tank 20 may also have tank water 22 above this level.

To permeate, the permeate valve 34 and an outlet valve 39 are opened and the permeate pump 32 is turned on. A negative pressure is created on the permeate side 25 of the membranes 24 relative to the tank water 22 surrounding the membranes 24. The resulting transmembrane pressure, typically between 1 kPa and 150 kPa, draws tank water 22 (then referred to as permeate 36) through the membranes 24 while the membranes 24 reject solids which remain in the tank water 22. Thus, filtered permeate 36 is produced for use at the permeate outlet 38. Periodically, a storage tank valve 64 is opened to admit permeate 36 to a storage tank 62 for use in backwashing. As filtered permeate 36 is removed from the tank, the feed pump 12 is operated to keep the tank water 22 at a level which covers the membranes 24 accounting for retentate removal during permeation, if any, or removal of foam or other substances, if any.

To backwash the membranes, alternately called backpulsing or backflushing, with permeation stopped, backwash valves 60 and storage tank valve 64 are opened. Permeate pump 32 is turned on to push filtered permeate 36 from storage tank 62 through a backwash pipe 63 to the headers 26 and through the walls of the membranes 24 in a reverse direction thus pushing away some of the solids attached to the membranes 24. The volume of water pumped through the walls of a set of the membranes 24 in the backwash may be between 10% and 40%, more often between 20% and 30%, of the volume of the tank 20 holding the membranes 24. At the end of the backwash, backwash valves 60 are closed. As an alternative to using the permeate pump 32 to drive the backwash, a separate pump can also be provided in the backwash line 63 which may then by-pass the permeate pump 32. By either means, the backwashing may continue for between 15 seconds and one minute. When the backwash is over, permeate pump 32 is then turned off and backwash valves 60 closed. The flux during backwashing may be 1 to 3 times the permeate flux and may be provided continuously, intermittently or in pulses.

To provide scouring air, alternately called aeration, the air supply pump 50 is turned on and blows air, nitrogen or other appropriate gas from the air intake 52 through air distribution pipes 54 to the aerators 56 located below, between or integral with the membrane elements 8 or cassettes 28 and disperses air bubbles 58 into the tank water 22 which flow upwards past the membranes 24.

The amount of air scouring to provide is dependant on numerous factors but is preferably related to the superficial velocity of air flow through the aerators 56. The superficial velocity of air flow is defined as the rate of air flow to the aerators 56 at standard conditions (1 atmosphere and 25 degrees Celsius) divided by the cross sectional area effectively scoured by the aerators 56. Scouring air may be provided by operating the air supply pump 50 to produce air corresponding to a superficial velocity of air flow between 0.005 m/s and 0.15 m/s. At the end of an air scouring step, the air supply pump 50 is turned off. Although air scouring is most effective while the membranes 24 are completely immersed in tank water 22, it is still useful while a portion of the membranes 24 are exposed to air. Air scouring may be more effective when combined with backwashing.

Air scouring may also be provided at times to disperse the solids in the tank water 22 near the membranes 24. This air scouring prevents the tank water 22 adjacent the membranes 24 from becoming overly rich in solids as permeate is withdrawn through the membranes 24. For this air scouring, air may be provided continuously at a superficial velocity of air flow between 0.0005 m/s and 0.015 m/s or intermittently at a superficial velocity of air flow between 0.005 m/s and 0.15 m/s.

To drain the tank 20, also called rejection, reject removal or bleed, the drain valves 40 are opened to allow tank water 22, then containing an increased concentration of solids and called retentate 46, to flow from the tank 20 through a retentate outlet 42 to a drain 44. The retentate pump 48 may be turned on to drain the tank more quickly, but in many installations the tank will empty rapidly enough by gravity alone, particularly where a reject bleed is desired during permeation. It may take between two and ten minutes to drain the tank 20 completely from full and less time to partially drain the tank 20.

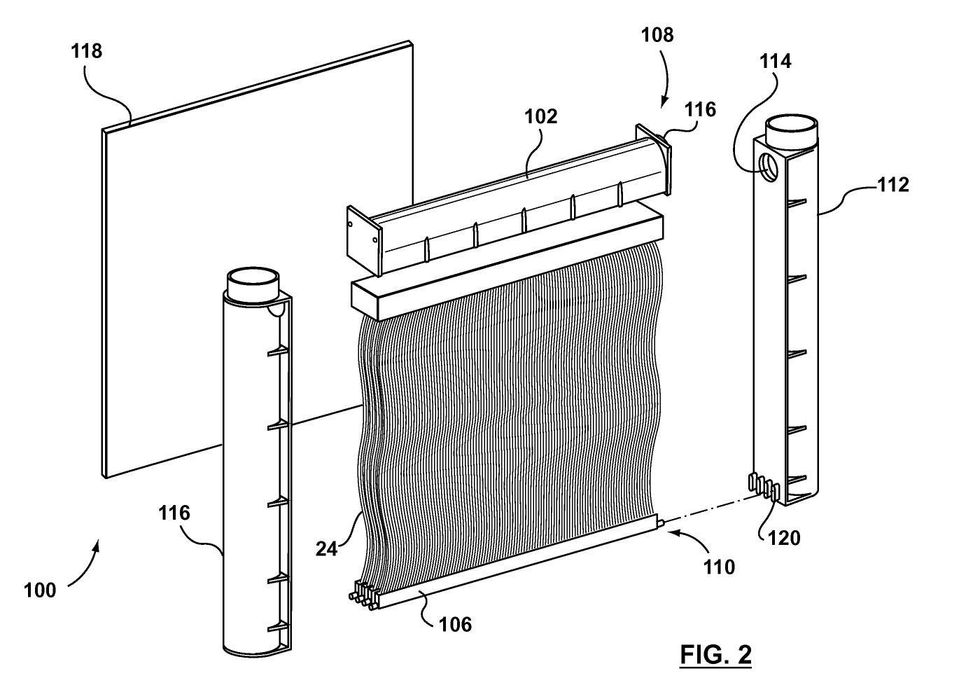

FIG. 2 shows a module 100. Module 100 has a plurality of membranes 24 shown as a block to simplify the drawing. Membranes 24 may be randomly arranged or arranged in rows or sheets as described in U.S. Pat. No. 6,592,759. U.S. Pat. No. 6,592,759 is incorporated herein, in its entirety, by this reference to it to show the arrangement of membranes 24 into sheets and various potting methods, but without limiting the claims of this document by any statements in the incorporated patent. Membranes 24 are potted at their upper ends in an upper block of potting material 104 with their ends, not shown, open to or at an upper surface of the upper block of potting material 104. The block of potting material 104 is attached and sealed at its edges to a permeate pan 102 which collects permeate discharged from the ends of the membranes 24. The lower ends of the membranes 24 are closed and potted into lower pans 106. Permeate pan 102 and the upper block of potting material 104 will be referred to as an upper header 108. A lower pan 106 and the potting material holding the membranes 24 in it (not shown) will be referred to as a lower header 110. Alternately, there may be multiple upper blocks of potting material, for example a block corresponding to each lower header 110, to be described below. The module 100 comprises a bundle of membranes 24 potted in an upper header 108 and potted in sub-bundles into multiple lower headers 100. The membranes 24 may be ordered into spaced sheets, that is rows of generally parallel membranes 24, with each lower header 110 containing a lesser number of sheets than the upper header 108. Other arrangements of membranes 24 may also be used. For example, a sub-bundle of the membranes 24 may be randomly arranged in a lower header 110. The membranes of the multiple sub-bundles may be mixed in the upper headers 108 or membranes 24 of a sub-bundle may be kept from mixing with membranes 24 of adjacent sub-bundles in the upper header 108. In the case where the sub-bundling is preserved in the upper header 108, the spacing between the membranes 24 may be increased and the spacing between adjacent sub-bundles decreased relative to the lower headers 110. In the case of membranes 24 arranged in sheets or rows, the rows may be generally evenly spaced in the headers 108, 110, but at a greater spacing in the upper header 108. The upper header 100 may have, for example, a bundle of membranes having from 8 to 30 rows or sheets of membranes and be from 5 to 20 cm in width. A lower header 110 may have, for example, from 1 to 5 rows or sheets of membranes and be from 0.5 to 4 cm in width. The headers 108, 110 may be elongated in plan view having a ratio of length to width of, for example, 2 or more or 4 or more or 8 or more.

The module 100 has a permeate conduit segment 112 with a permeate inlet 114 adapted to receive a permeate outlet 116 of the upper header 108. A gas conduit segment 116 may be connected to the opposite end of the upper header 108. A shroud plate 118 may be connected between the conduit segments 116, 118 on one or both sides of the module 100. Gaps between the upper header 108 and shroud plate 118 permit fluid flow vertically through the module 100. Lower header fittings 120 molded into the conduit segments 112, 116 are adapted to receive the ends of the lower headers 110 and to hold the lower headers 110 at a fixed displacement from the upper headers 108. The fittings 120 may have a plurality of receptacles such that the lower headers 110 may be held at varying displacements from the upper header 108.

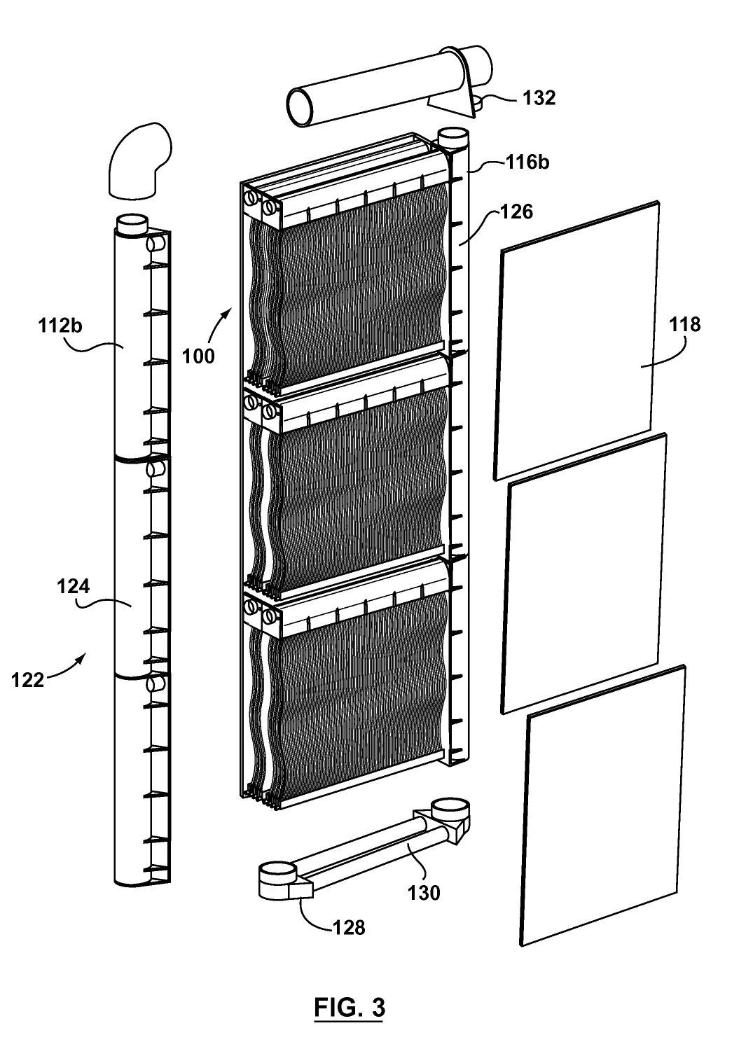

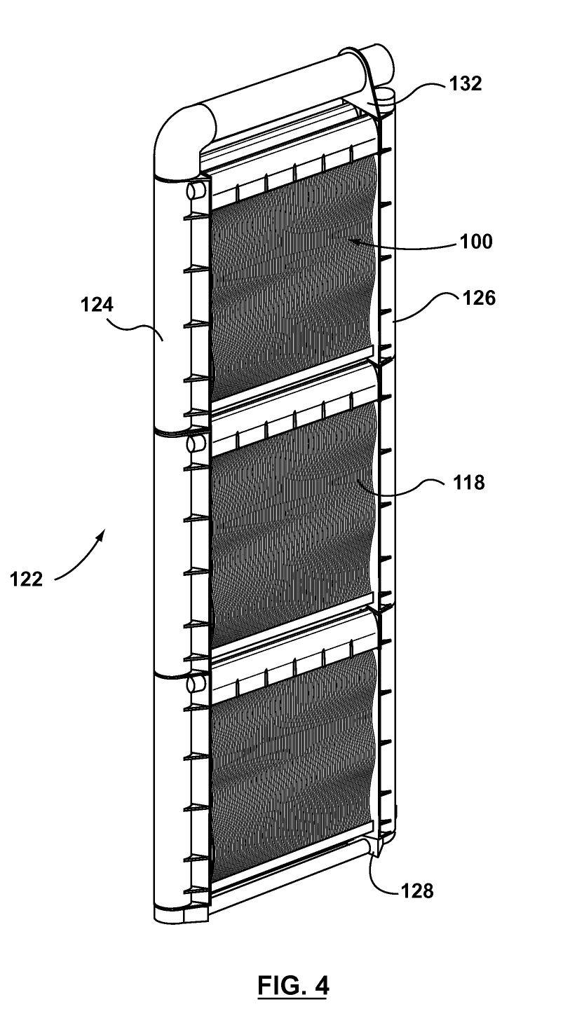

FIGS. 2 and 3 show a plurality of the modules 100 combined into a cassette 122. The modules 100 as shown are stacked three high in two columns although other arrangements may be used. Second stacked permeate conduit segments 112b, each connected to two modules 100, attach end to end to create part of a permeate conduit 124. Stacked second gas conduit sections 116b, each connected to two modules 100, connect together end to end to form part of a gas conduit 126. A lower fitting 128 comprises one or more aerator tubes 130 and is attached to the bottom ends of conduits 124, 126. The lower fitting 128 caps the lower end of permeate conduit 124 and connects the lower end of gas conduit 126 to the aerators 130. The lower fitting 128 also provides a base to support the cassette 122 on the bottom of the tank 20 of FIG. 1.

An upper fitting 130 connects the upper end of gas conduit 126 to a gas fitting (not visible) for connection to a gas distribution pipe 51 of FIG. 1. The upper fitting 132 also optionally supports an end of permeate conduit 124. The end of permeate conduit 124 may be attached to a permeate collector 30 of FIG. 1. Side panels 118 are provided on a side of each module 100 and together with the conduit segments 112, 116 form a vertical flow channel above the aerators 130 containing the membranes 24.

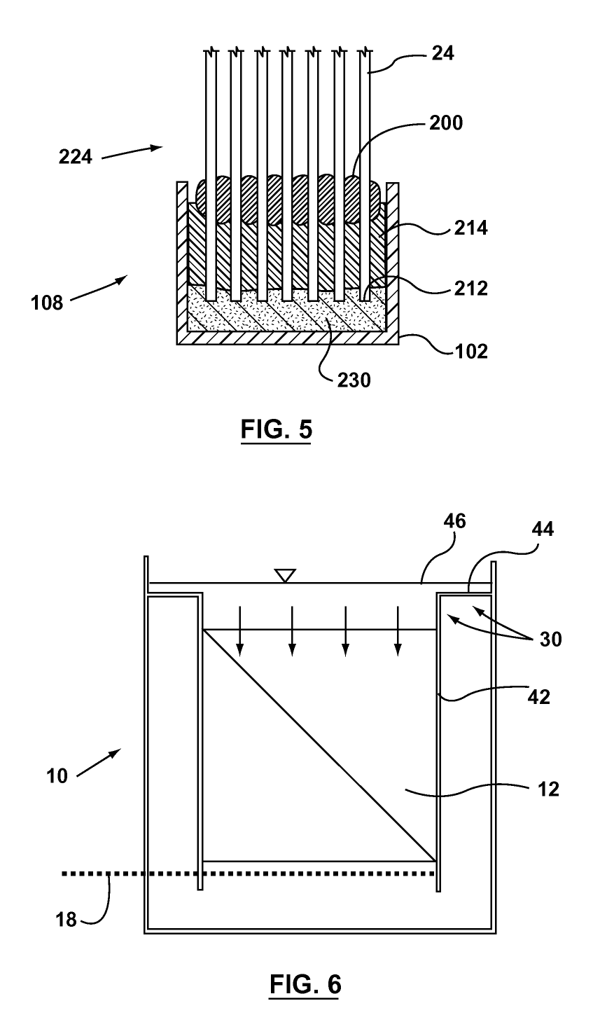

FIG. 5 shows an upper header 108 being assembled. Membranes 24 are arranged in a group 224 having a plurality of membranes 24 surrounded by a solidified adhesive 200 near the ends 212 of the membranes 24. The ends 212 of the membranes 24 extend beyond the adhesive 200. The membranes 24 are generally separated and individually surrounded by solidified adhesive 200 although, with a sufficient depth of a suitable resin 214 it is permissible for membranes 24 to be touching each other in the solidified adhesive 200. The membranes 24 may be closely spaced apart either regularly or randomly within rows or sheets separated roughly by a desired thickness, typically between ¼ to ¾, more typically between ⅓ to ½, of the outside diameter of the membranes 24. The adhesive 200 is water insoluble, durable in a solution of any chemicals likely to be present in a substrate to be filtered and substantially non-reactive with the membrane material or resin 14.

Adhesive 200 may be polyethylene hot melt adhesive made of a blend of ethelyne vinyl acetate co-polymers.

The group 224 is formed of a number of layers, rows or sheets of membranes 24. A layer is formed by placing a desired number of membranes 24 onto a surface coated or covered with a strip of material that will not adhere to the adhesive 200. The membranes 24 may have already been cut to length and have open ends or may be all continuous as in a fabric or a series of loops of fibres. The membranes 24 are preferably laid down so as to be spaced apart from each other by either random or, more preferably, regular width spaces. A strip of adhesive 200 of about 2-3 cm in width is placed across the membranes 24 near any place where ends of the membranes 24 will be potted according to this embodiment but leaving space for the open ends 212 of the membranes 24 to extend beyond the adhesive 200. A groove may be made in the surface below where the adhesive 200 will be laid down if necessary to allow the adhesive to surround the membranes 24. Optionally, the adhesive may be re-melted with an iron to help the adhesive surround each membrane but the adhesive is re-solidified before it can wick up the membranes appreciably. After a desired number of layers have been made, the layers are put together at the bands of adhesive 200 to form the second group 224. The layers may be simply clamped together or glued together with more adhesive 200. If the membranes 24 will be potted using a fugitive material, the membranes 24 are preferably cut open before the layers are put together into the second group 224 if they were not cut open before being formed into layers.

The second group 224 may be potted using various techniques. For example, the second group 224 may be placed into a container holding a depth of resin 214. The second group 224 is immersed in the resin 214 such that the ends of the membranes 24 are covered by the resin 214 and the adhesive 200 is partially, typically about half way, submerged in the resin 214. Thus resin 214 extends from the periphery of the adhesive 200 towards the ends of the membranes which protrude from a first side of the adhesive 200. The resin 214 surrounds each membrane 24 for at least a portion of its length in the resin 214 between the adhesive 200 and the end of each membrane 24. When the resin 214 solidifies, it sealingly connects to the outside of each membrane 24 but does not contact the membranes where they exit on top of the adhesive 200. The ends of the membranes 24 may have been placed in the resin 224 or other fixing liquid unopened. The block of solidified fixing liquid is cut to open the ends of the membranes 24. The solidified fixing liquid is attached to a header pan in a position where the open ends of the membranes can be in fluid communication with a permeate channel in the header.

As shown in FIG. 5, however, the second group 224 is potted into a fugitive material, for example, a fugitive gel 230. The second group 224 is inserted into a header pan 102 such that the open ends 212 of the membranes 24 are inserted into the gel 230 to a depth of about 5 mm. The adhesive 200 is not inserted into the gel 230. Liquid resin 214 is then poured to a desired depth which surrounds the periphery of the adhesive 200, and extends about one half of the way to the top of the adhesive 200.

The lower headers 110 may be assembled in a similar way except that fewer layers of membranes 24 are involved for each lower header 110. Also, since the lower headers 110 are non-permeating, the fugitive gel 230 is not used and more resin 214 is put into the lower pans 106 instead.

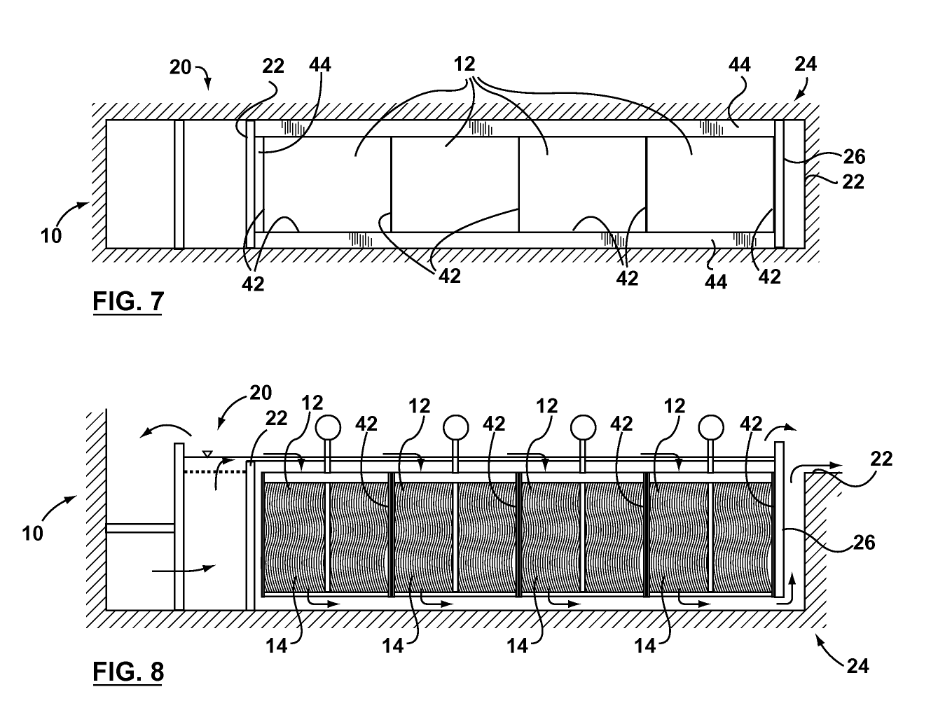

Referring to FIGS. 6 to 10, a water treatment plant may have one or more process tanks (not shown) and one or more membrane tanks 310. Raw waste water may enter the plant at an average rate Q and recirculate through the process tanks and membrane tank 310, for example at a rate of flow to the relevant tank 310 of 4-7 Q. Permeate may be withdrawn at a rate near, although generally less than, 1 Q, for example by suction, siphon or gravity, from membrane tank 310. Recirculating flow thus leaves the membrane tank 310 at almost 1 Q less than the flow rate to the membrane tank 10, for example at 3-6 Q. Sludge is wasted from the plant at a rate that provides a mass balance for the plant, the total of the permeate removal and sludge wasting rates generally equaling the feed rate. The plant may be similar to any of those shown in International Publication No. WO 2005/039742.

The membrane tank 310 contains one or more cassettes 312. Each cassette 312 may have a number of membrane units 314 held together in a frame. For example, the cassette 312 may comprise one or more ZW 500 membrane modules made by Zenon Environmental Inc. The cassettes may be like those described in U.S. Publication No. 2002/0179517 or other cassettes, for example cassettes having membrane units 314 with a modified or no lower header. The cassettes 312 are connected to a permeate pipe 316 for removal of permeate and an aeration system 318 to provide scouring gas bubbles near or below the bottoms of the cassettes 312.

Membrane tank 310 has an inlet 320 which may, for example, flow mixed liquor over a weir 322 into one end of membrane tank 310. A pipe or other inlet may also be used. Membrane tank 310 also has an outlet 324 for removing activated sludge from membrane tank 310 for recycle for example to an upstream process tank. Outlet 324 has a baffle 326 which mixed liquor flows under from the bottom of tank 310 before flowing upwards, downstream of baffle 326, and exiting over another weir 322. A pipe or other outlet may also be used.

Each cassette 312 is surrounded by a shroud 330 including vertical plates 342 on all four sides of the cassette 312. Cassette 312 may occupy 80% or more or 90% or more of the horizontal area contained within vertical plates 342. Shroud 330 also comprises horizontal plates 344 extending from the tops of the vertical plates 342 parallel to the length of membrane tank 310 to the walls of membrane tank 310. Parts of the walls of the membrane tank 310 may optionally be used to provide parts or all of shroud 330.

Mixed liquor flowing over weir 322 of inlet 320 fills membrane tank 310 to a surface level 346 above the tops of vertical plates 342. This inflowing mixed liquor flows, and is distributed, along the length of membrane tank 310 above the cassettes 312. Mixed liquor also flows downwards through vertical channels created by shrouds 330 around the cassettes 312. Mixed liquor flows past the cassettes 312 generally in parallel until reaching a space between the bottom or sides of the shrouds 330 and the bottom or sides of the membrane tank 310. The mixed liquor then flows horizontally through this space to the outlet 324. Mixed liquor then leaves the membrane tank 310 over the weir 322 of outlet 324. The arrows in FIGS. 6 to 10 further describe the flow of mixed liquor through the membrane tank 310.

Mixed liquor may flow generally continuously through the membrane tank 310 for an extended period of time as described above, for example more than a day, except when interrupted for example for membrane cleaning or other maintenance procedures. For example, during membrane backwashes, which may be performed once an hour or more, the mixed liquor level in membrane tank 10 may rise to a level that allows foam to overflow baffle 326. This may allow some mixed liquor to bypass the cassettes 312, but usefully removes foam from the membrane tank 310. A permeation process may be generally continuous over the extended period of time, although the process may include interruptions for periodic membrane backwashing, cleaning or relaxation procedures. Scouring bubble processes may also be provided generally continuously over the extended period of time, although the flow of gas in the process may be under a regime in which air flow is stopped or reduced cyclically or intermittently. Variations in gas flow may coincide with variations in permeation, for example, air flow may be increased or stopped during backwashing, cleaning or relaxation procedures. For further example, gas bubbles may be provided while permeating generally according to a cycle in which air is provided in cycles to the aerators at a higher rate for 5 to 20 seconds, for example 10 to 15 seconds, and then at a lower rate for 10 to 50 seconds, for example 10 or 20 to 40 seconds. The lower rate may be between 0 and 10% of the higher rate. The cycles may be staggered between multiple aerators such that one aerator may have air at the highest rate while one or more others have air at the lower rate. Such an aeration regime is described in U.S. Pat. No. 6,550,747 which is incorporated herein its entirety by this reference to it. Downward velocity of mixed liquor through or into spaces in cassettes 12 between membrane units may be 3-20 cm/s. The average size of the gas bubbles or some of the gas bubbles may be a size of bubble that rises at 5-20 cm/s or 10-20 cm/s in still water.

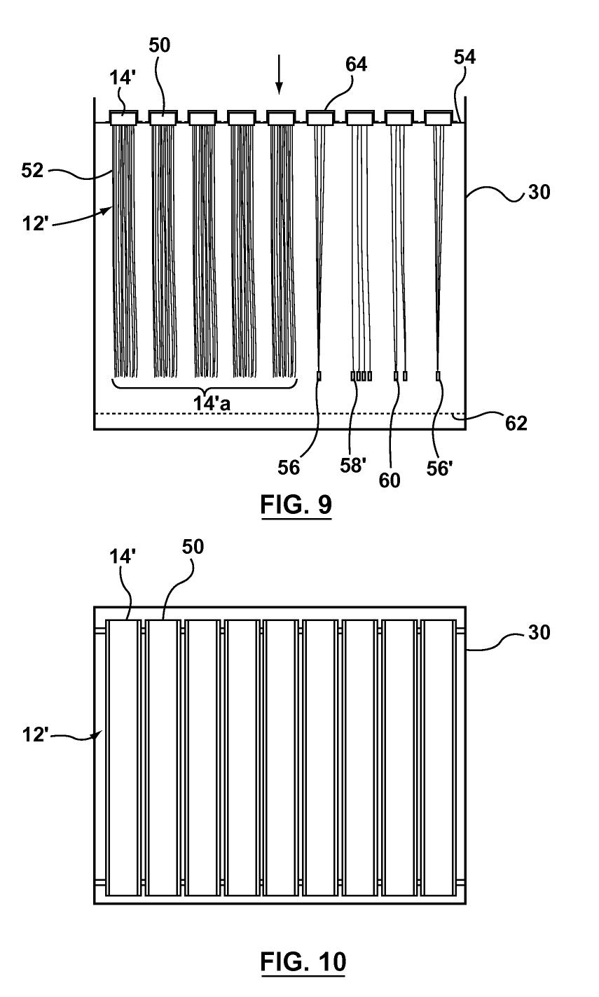

FIGS. 9 and 10 show a portion of membrane tank 310 surrounded by casing 330 and containing a second cassette 312′. Second cassette 312′ has second membrane units 314′ which each have an upper header 350 and hollow fiber membrane 352 extending downwards from upper header 350. Upper headers 350 have a permeate channel within them and are connected to permeate pipe 316. A frame 354 holds upper headers 352 together in second cassette 312′ and to in turn allow second cassette 312′ to be held in tank 310. Optionally, a second of more second cassettes 312′ may be stacked vertically within shroud 330. The lower ends of membranes 352 may be individually closed and free as in second membrane units 314′a. Optionally, the lower ends of the membranes 352 may be held in a lower header 356. Lower header 356 may be narrower than upper header 350, may optionally be without a permeate cavity and may be generally freely suspended on membranes 352 or may be unattached to frame 354 other than by way of the membranes 312. Further optionally, a group, for example a row, of membranes 352 may be held in a lower sub-header 358 which may be freely suspended from membranes 352 or unattached to frame 354. Further optionally, larger groups or multiple rows of membranes 352 may be held at their lower ends in a larger second header 360, which may be freely suspended from membranes 352 or unattached to frame 354. Such grouping of the lower ends of membranes 352 reduces or prevents them from becoming entangled and thereby reducing membranes 352 movement which causes flow to bypass rather than go through membranes 352. The downwards flow of mixed liquor may be sufficient to keep membranes 352 hanging downwards or, optionally the lower ends of membranes 352 or lower header 356 or lower sub-headers 358, 360 may be weighted. Further optionally, frame 354 may include a lower frame part 362 that attaches to any of lower header 356, lower sub-header 358 or second lower sub-header 360 and fixes their positions. Further optionally, baffles 364 may be placed over upper headers 350 and block part of the gaps between upper headers 350.

In the configuration of FIGS. 6 to 8, the velocity of recirculating water is greater into the top of filtration units 314 than out of the bottom of the filtration units 314 because of the water removed as permeate. This effect is enhanced in the configuration of FIGS. 9 and 10 by also providing an area for flow past baffles 364 or between headers 356 in the area of the membranes 352 that is less than the area for flow available for recirculating water to exit the area of membranes 352. Bubbles may be provided of a size that allows them to rise upwards against the downward flow into the area of the membranes 352 but insufficient to allow them to continue to rise upwards out of the area of the membranes 352. Bubbles may thus be temporarily retained in the area of the membranes 352 until they combine with other bubbles to a size large enough to rise out of the area of the membranes 352. For example, bubbles of about 0.5 cm diameter rise at about 20 cm/s while bubbles of a diameter of 2 cm or more may rise at about 28 cm/s with a generally linear relationship between bubble diameter and rise velocity between these points. Rise velocity rapidly decreases as diameter decreases below about 0.5 cm diameter. A cassette 312′ may be provided with no lower header as in any of the filtration units 314′ having an area for flow into the area of the membranes 352 of between, for example, 10 and 40% of the total horizontal cross-sectional area of the cassette 312′. However, area for flow downwards out of the cassette 312′ may be, for example, 70-90% of the total horizontal cross-sectional area of the cassette 312′. As a result, velocity of downward water flow into the area of the membranes 352 may be, for example, between 2.5 and 7 times the velocity of the water in the area of the membranes and 2 to 6 times the velocity flowing out of the area of the membranes 352. For further example, velocity into the membranes 352 area may be between 3 and 20 cm/s while velocity in the membrane area may be lower, for example, between 1 and 4 cm/s. Fine bubbles, for example of an average size of 0.5 cm or less, or including bubbles of 0.5 cm or less, can flow into the membranes 352 area but cannot readily rise past the membranes 352 area. Optionally, coarser bubbles may be used and allowed to rise rapidly into the cassette 312′ then proceed more slowly through, or temporarily accumulate near, the top portion of cassette 312′. An increase in bubble residence time near the top of cassette 312′ may be beneficial because sludging might otherwise occur there due to the headers 350 interfering with water and bubble flow and local permeate flow being higher due to head loss in the lumens of the membranes 352. Further, although the average size of the bubbles leaving an aerator may be sufficient to rise out of the cassette 312, 312′, some smaller bubbles will be produced and local eddies or currents with larger than average velocity will temporarily retain even larger bubbles, thereby increasing bubble retention.

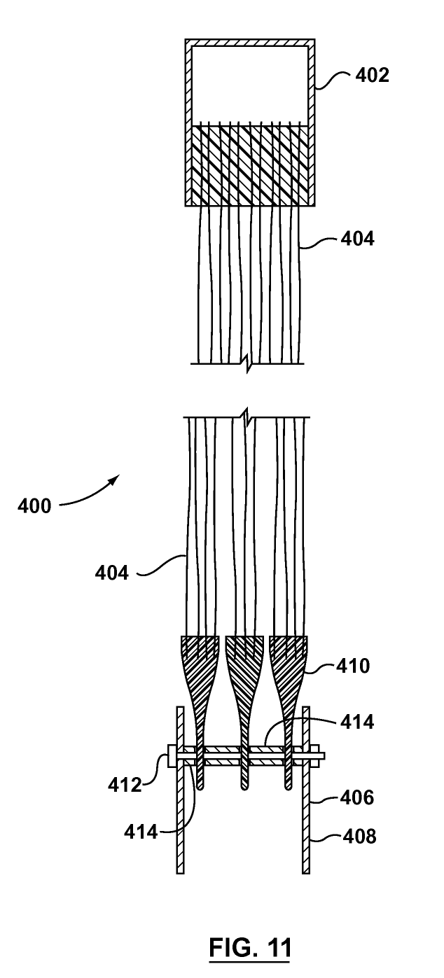

FIG. 11 shows a alternative module 400. Module 400 was created by modifying a ZeeWeed 500d module. ZeeWeed 500d modules are available commercially from GE Water and Process Technologies and similar modules are described in U.S. Pat. No. 7,037,426 which is incorporated herein in its entirety by this reference to it. The 500d module has an upper permeating header 402 and, in this example, 11 rows of membranes 404. Each row of membranes 404 has, in this example, 240 individual membranes represented in FIG. 11 by the single membrane at the end of the row visible when looking at the edge of the module. In the 500d modules, the lower ends of the membranes are potted into a lower header and the upper and lower headers are designed to removably engage a cassette frame which hold multiple modules at a selected spacing between modules and spacing between the upper and lower headers. In module 400 of FIG. 11, the 500d lower header has been replaced by a hollow perimeter frame 406. Perimeter frame 406 is adapted to mount into the 500d cassette frame but is open between its side walls 408 such that water and air bubbles can flow up or down through the perimeter frame 406. The lower ends of the rows of membranes 404 are divided into three groups and potted into one of three sub-headers 410. Each sub-header 410 was made by placing the ends of 3 or 4 rows of membranes 404 into a fixture lined with a mesh screen, not visible, and then filled with urethane potting resin. The potting resin in this example seals the ends of the membranes, although a lower sub-header could also be made with a cavity or embedded tube for withdrawing permeate. The mesh screen coated with potting resin provides sufficient physical strength to the rows of membranes 404 to dispense with a pre-molded header cavity. The sub-headers 410 are attached to the perimeter frame 406 by means of a series of bolts 412 passing through holes in the sub-headers 410. A set of washers and nuts or other spacers 414 on the bolts 412 keeps the sub-headers 410 spaced from the side walls 408 and each other. When multiple modules 400 are inserted into a 500d cassette frame, there are gaps for bubbles or water to flow upwards or downwards between sub-headers 410 within a module 400 and between the adjacent sub-headers 410 of adjacent modules 400.

### EXAMPLE

A set of 8 of the modified modules 400 of FIG. 11 was placed in a cassette and was used to filter mixed liquor at 13-15 C and re-circulated conventionally without forcing the mixed liquor to flow downwards through the cassette. After some short term fouling rate tests, the cassette was tested for three weeks under continuous aeration applied under a 10 seconds on, 10 seconds off cycle at normal 500d aeration rates and a 9/1 production cycle. The flux setpoints for the test were elevated to 18 gfd for 20 hours with two 2 hour peaks of 30 gfd during weekdays and 27.5 gfd instantaneous flux during weekends. The cassette was backwashed with permeate as for a normal 500d cassette, but no chemical cleaning was conducted during the test.

The flux setpoints used for the three week test were at least 20% higher than standard 500d flux rates. Despite the increased flux rate and lack of chemical cleaning, TTF remained below 100s for the entire test. The TMP for the modules 400 showed only about a 10 kPa increase at 18 and 27.5 gfd, and only about a 15 kPa increase at the peak 30 gfd flux. Based on past test results, similar increases in TMP would be expected with standard modules under lower flux setpoints. Further, with a standard 500d module operated under these conditions, sludge deposits would be expected along the length of the bottom header up to about 7.5 cm of the bottoms of the membranes, vertically along the outside edges of the modules and randomly within the membrane bundle. With the modified module 400, very little sludge was found in any of these locations. During the short term fouling rate tests, the modified module 400 showed reduced fouling rates compared to data on standard modules despite only permeating from one end of the membranes and not optimizing the membrane length for single ended operation. For example, at a flux of 25 gfd the modified module 400 had a fouling rate of about 0.1 kPa/min whereas tests on a standard module at the same flux under the same operating procedure and in the same facility showed a fouling rate of about 0.15 kPa/min. The inventors believes that this increase in performance results from increased penetration of the air bubbles into the bundle of membranes, possible enhanced by increased movement of the membranes resulting from flexing of the sub-modules 410.

The invention or inventions protected by this document are defined by the following claims.

We claim:

1. A membrane module comprising an upper header, multiple lower headers and a bundle of membranes potted at one end in the upper header and at their opposed ends into the multiple lower headers.

2. The module of claim 1 wherein the upper header and the lower headers are rectangular in plan view, the lower headers are as long as the upper header but collectively narrower than the upper header, and the lower headers are located below and spaced across the width of the upper header.

3. The module of claim 1 or 2 wherein the membranes may be arranged in the upper header into a number of generally parallel sheets or planes and arranged into a lower header into a lesser number of sheets or planes.

4. The module of any of claims 1 to 3 further comprising vertical shroud on the sides of the modules.

5. The module of any of claims 1 to 4 wherein the lower headers are constrained in a spaced apart relationship from each other in a direction generally perpendicular to the membranes.

6. The module of any of claims 1 to 5 wherein the lower headers are constrained in a spaced apart relationship from the upper header in a direction generally parallel to the membranes.

7. The module of any of claims 1 to 6 wherein the lower headers are flexible or mounted such that they may move perpendicularly to the membranes.

8. A filtration apparatus having a plurality of membranes potted at their upper ends in a single bundle and potted at their lower ends in multiple bundles separated by spaces permitting a vertical flow of bubbles or liquid past the lower ends of the membranes.

9. An assembly of a plurality of modules according to any of claims 1 to 8 stacked vertically.

10. A process comprising steps of immersing a module according to any of claims 1 to 8 in a tank of water and providing air bubbles in the water from below the lower headers.

11. A process comprising steps of immersing a module according to any of claims 1 to 8 in a tank of water during permeation and draining and refilling the tank to deconcentrate the water in the tank.

12. A water treatment plant comprising a membrane tank, a plurality of cassettes in the tank, an inlet to the tank, an outlet from the tank and shrouds or baffles arranged to provide a flow path from the inlet to the outlet through the cassettes in parallel.

13. The plant of claim 12 wherein shrouds or baffles are arranged such that the cassettes occupy 80% or more or 90% or more of the cross-sectional area of the flow path.

14. A water treatment plant comprising a membrane tank, a membrane cassette in the tank, a flow path for recirculating mixed liquor downwards through the cassette and an area for flow into the cassette less then the area for flow out of the cassette.

15. A process comprising steps of treating water in a plant comprising steps of flowing mixed liquor through a plurality of immersed membrane cassettes in parallel.

16. The process of claim 15 wherein the mixed liquor flows downwards through spaces between membrane units in the cassette at a rate similar to the still water rise velocity of gas bubbles provided near the bottom of the cassette.

17. A process comprising steps of flowing recirculating mixed liquor downwards into a cassette at a first velocity and flowing mixed liquor downwards out of the cassette at a second velocity, the second velocity being one half or less of the first velocity, and providing bubbles or including bubbles having a rise velocity greater then the second velocity but lower than the first velocity.

18. A process comprising steps of flowing water to be filtered downwards through a module according to any of claims 1 to 8.

19. The process of claim 18 wherein the water is mixed liquor recirculated at a rate greater then the feed rate to the process.

20. A process comprising steps of providing a module according to any of claims 1 to 8 in a tank, recirculating mixed liquor through the tank, withdrawing permeate from the mixed liquor and providing bubbles in the mixed liquor which rise upwards into the module.
